(19) United States
(12) Patent Application Publication
(10) Pub. No.: US 2012/0083198 A1
(43) Pub. Date: Apr. 5, 2012

(54) FLUID CLEANING SYSTEM AND METHOD

(75) Inventors: Richard R. Sinur, Grafton, WI (US); Brian R. Wellnitz, Grafton, WI (US); Stephen Swenerton, Boulder, CO (US)

(73) Assignee: Broan-NuTone Company , LLC, Hartford, WI (US)

(21) Appl. No.: 13/251,958

(22) Filed: Oct. 3, 2011

Related U.S. Application Data
(60) Provisional application No. 61/389,110, filed on Oct. 1, 2010.

(51) Int. Cl. F24F 7/00; B23P 11/00

(52) U.S. Cl. 454/237; 454/339; 29/428

(57) ABSTRACT

Embodiments of the invention provide a fluid cleaning system. The system can include a housing capable of being coupled to a building structure. At least one first intake, at least one second intake, and at least one outlet are disposed through a portion of the housing. A ventilating assembly is supported within the housing and is capable of generating a fluid flow. In some embodiments, at least one detection apparatus is in communication with the ventilating assembly. At least one shutter is operatively coupled to the housing. The shutter is configured and arranged to move between at least a first position and a second position. At least one filter can he supported within the housing.

### RELATED APPLICATIONS

This application claims priority under 35 U.S.C. §119 to U.S. Provisional Patent Application No. 61/389,110 filed on Oct. 1, 2010 the entire contents of which is incorporated herein by reference.

### BACKGROUND

Some conventional range hoods can be designed to provide light to a range top and to ventilate cooking effluent during operation of the range top. Additionally, conventional over the-range microwaves can perform similar functions. These conventional apparatuses can capture relatively large volumes of effluent and either vent it to the atmosphere through a duct system or re-circulate it to the local environment after it passes through filters.

### SUMMARY

Some embodiments of the invention provide a fluid cleaning system that can include a housing. In some embodiments, at least one first intake and at least one second intake can be disposed through a portion of the housing. In some embodiments, at least one outlet can be disposed through a portion of the housing. In some embodiments, a ventilating assembly can be at least partially supported within the housing and can he configured and arranged to generate fluid flow. In some embodiments, the system can include at least one detection apparatus that can be in communication with the ventilating assembly. In some embodiments, the system can include at least one shutter that can be operatively coupled to the housing. In some embodiments, the shutter can be configured and arranged to move between at least a first position and a second position. In some embodiments, at least one filter can he supported within the housing.

Some embodiments of the invention provide a fluid cleaning system that can include a housing. In some embodiments, at least one first intake and at least one second intake can he disposed through a portion of the housing. In some embodiments, at least one outlet can be disposed through a portion of the housing. In some embodiments, the housing can include at least one first flow path and at least one second flow path. In some embodiments, at least one shutter can he operatively coupled to the housing. In some embodiments, the shutter can be configured and arranged to move between at least a first position and a second position. In some embodiments, the first position can obstruct at least of portion of the second flow path and the second position can obstruct at least a portion of the first flow path. In some embodiments, at least one detection apparatus can be coupled to the housing. In some embodiments, a plurality of filters can be supported within the housing. In some embodiments, at least a portion of the plurality of filters can he in fluid communication with the first flow path and another portion of the plurality of filters can be in fluid communication with the second flow path. In some embodiments, a ventilating assembly can be supported within the housing and can he configured and arranged to generate a fluid flow through the housing.

### DESCRIPTION OF THE DRAWINGS

FIG. 1 is a perspective view of a fluid cleaning system according to one embodiment of the invention.

FIG. 2 is a bottom perspective view of the fluid cleaning system of FIG. 1.

FIG. 3 is a cross-sectional view of a portion of the fluid cleaning system of FIG. 1.

FIG. 4A is a side view of a fluid cleaning system according to one embodiment of the invention.

FIG. 4B is perspective view of the fluid cleaning system of FIG. 4A.

FIG. 5A is a side view of a fluid cleaning system according to one embodiment of the invention.

FIG. 5B is perspective view of the fluid cleaning system of FIG. 5A.

FIG. 6 is a perspective view of a fluid cleaning system according to one embodiment of the invention.

FIG. 7A is a perspective view of a fluid cleaning system according to one embodiment of the invention.

FIG. 7B is a perspective view of a fluid cleaning system according to one embodiment of the invention.

### DETAILED DESCRIPTION

Before any embodiments of the invention are explained in detail, it is to he understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to he accorded the widest scope consistent with the principles and features disclosed herein. The following detailed description is to he read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

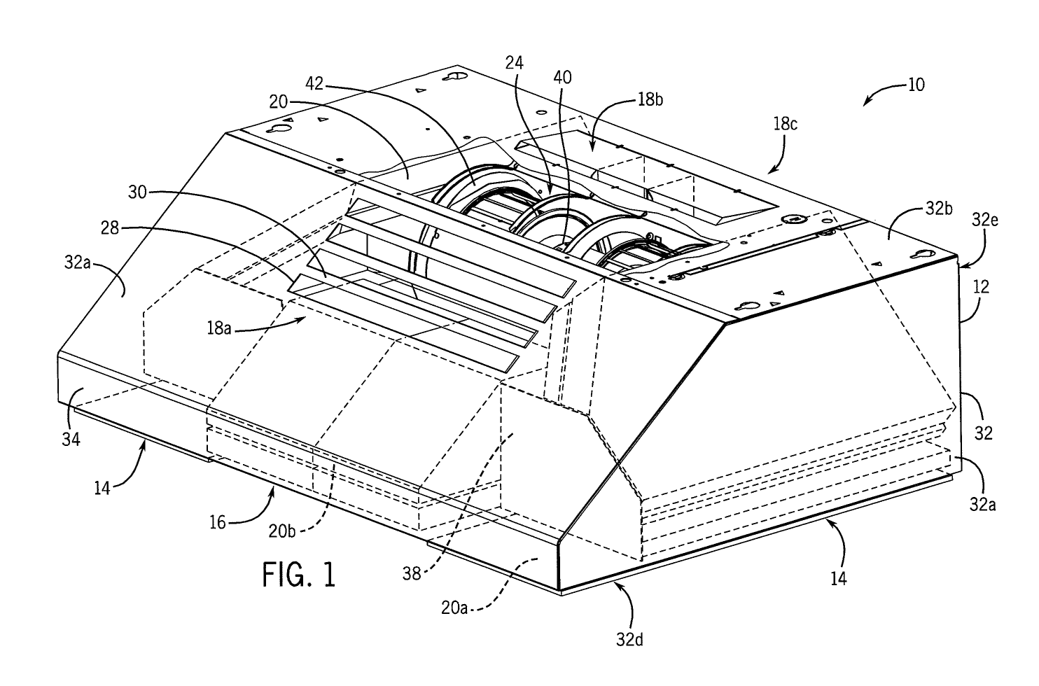

FIG. 1 illustrates a fluid cleaning system 10 according to one embodiment of the invention. In some embodiments, the fluid cleaning system 10 can include a housing 12, at least one first intake 14, at least one second intake 16, at least one outlet 18, a plurality of filters/media 20, a light assembly 22, a ventilating assembly 24, at least one shutter 26, a user interface (not shown), and a detection apparatus (not shown). Moreover, as described in further detail below, in some embodiments, the system 10 can comprise multiple modes of operation. Furthermore, although this system 10 is described for use in a cooking area, the fluid cleaning system 10 can also be employed in any areas of any structures where fluid exhaust and/or fluid filtration generally are desired (e.g., a garage, a work area, a bathroom, a bedroom, etc.). Moreover, in some embodiments, the system 10 can be a part of and/or interface with an indoor air quality system, such as the one disclosed in U.S. patent application Ser. No. 11/135,129. The entire contents of this application are hereby incorporated by reference. Briefly, in some embodiments, the system 10 can track volumes of fluid exhausted and/or cleaned and communicate with the indoor air quality system (e.g., via a wired or wireless connection). In some embodiments, fluid can comprise air, including airborne contaminants, mists, gases, effluent originating from various sources (e.g., cooking surfaces), and any other types of fluids.

According to some embodiments of the invention, the system 10 can be at least partially disposed within the housing 12. In some embodiments, the housing 12 can be mounted to a building structure near a source of odors, volatile organic compounds (VOCs), fine particulates, or any other product or pollutant which a user would like to remove from the local environment. In some embodiments, the housing 12 can be coupled to the building structure in any suitable manner (e.g., conventional fasteners, adhesives, welding, brazing, etc). By way of example only, in some embodiments of the invention, the desired building surface can he an area above a stove top or a range. In this location, the system 10 can capture relatively large volumes of cooking effluent.

According to some embodiments, the housing 12 can comprise a plurality of panels 32. For example, in some embodiments, the housing 12 can include at least one front panel 32a, at least one upper panel 32b, a plurality of side panels 32c, at least one lower panel 32d, and at least one rear panel 32e. As shown in FIG. 1, the panels 32 can be assembled to generally house, receive, and/or support some elements of the system 10. In some embodiments, when assembled, the rear panel 32e can be at least partially substantially adjacent to a building structure onto or into which the housing 12 can be coupled and/or installed. For example, after assembly of the housing 12, as detailed below, in some embodiments, the rear panel 32e and/or other portions of the housing 12 can be coupled (e.g., via conventional fasteners, adhesives, interference fitting, welding, brazing, etc.) to a portion of the structure (e.g., a wall, an island, a joist, a cabinet, etc.) so that the system 10 can be substantially retained in a predetermined position.

In some embodiments, the rear panel 32e can he coupled to other portions of the housing 12 (e.g., other panels 32). For example, in some embodiments, the rear panel 32e can be coupled to the lower panel 32d, the upper panel 32b, and the side panels 32c in any suitable manner. For example, in some embodiments, the panels 32 can be coupled together via conventional fasteners, adhesives, interference fitting, welding, brazing, or other coupling methods. Moreover, in some embodiments, at least a portion of the panels 32 can he substantially integral with each other so that the housing 12 is formed froth a lesser number of panels 32. In some embodiments, the front panel 32a can be coupled to the housing 12 at an angle (e.g., 30 degrees, 90 degrees, 120 degrees, etc.) relative to the upper panel 32b. Moreover, in some embodiments, the front panel 32a can be coupled to at least one of the upper panel 32b and the side panels 32c in any of the previously mentioned coupling manners. For example, in some embodiments, the upper panel 32a and the side panels 32c can be one unit so that they are coupled to the other panels 32 at the same time. Moreover, in some embodiments, any combination of the previously mentioned panels 32 can be substantially integral with each other.

In some embodiments, the housing 12 can comprise a first outlet 18a, as shown in FIG. 1. For example, in some embodiments, at least a portion of the front panel 32a can comprise the first outlet 18a. Moreover, in some embodiments, the housing 12 can comprise a louver assembly 28 substantially adjacent to the first outlet 18a. For example, in some embodiments, the louver assembly 28 can be coupled to a portion of the front panel 32a and/or other portions of the housing 12 at a position substantially immediately adjacent to the first outlet 18a. In some embodiments, the louver assembly 28 can be coupled to the front panel 32a so that it at least partially extends over (e.g., covers) the first outlet 18a. In some embodiments, the louver assembly 28 can comprise at least one louver 30 configured and arranged to guide at least a portion of the fluid exiting the system 10. In some embodiments, the first outlet 18a can fluidly connect the ventilating assembly 24 and other elements of the system 10 with the local environment. By way of example only, in some embodiments, a fluid, such as ambient air, can circulate through the system 10 and exit it via the first outlet 18a.

In some embodiments, the housing 12 can comprise a second outlet 18b. In some embodiments, the upper panel 32b can comprise at least a portion of the second outlet 18b. In some embodiments, the second outlet 18b can fluidly couple the system 10 with a ventilating system of the structure into which the system 10 is installed. For example, in some embodiments, the second outlet 18b can fluidly connect portions of the system 10 (e.g., the ventilating assembly 24) and a duct system (not shown) of the structure. As a result, in some embodiments, the system 10 can direct at least a portion of the fluid into the duct system via the second outlet 18b so that the fluid can be vented from the local environment, which can include venting outside of the building structure. In other embodiments, the duct system can be absent and the second outlet 18b can guide at least a portion of the fluid into a duct-free system comprising filters (e.g., carbon filters) (not shown) and then the filtered fluid can be re-circulated back to the local environment. In some embodiments, the housing 12 can comprise a third outlet 18c. In some embodiments, the third outlet 18c can be disposed through a portion of the rear panel 32e and can be in fluid communication with at least one of the local environment, the duct-free system, and/or the duct system for exhausting fluid.

In some embodiments of the invention, a front member 34 can he coupled to the housing 12. For example, as shown in FIG. 1, in some embodiments, the front member 34 can he coupled to at least one of the front panel 32a, the side panels 32c, and the lower panel 32d. In some embodiments, the front member 32 can be coupled to the housing 12 so that it is oriented substantially parallel to the rear panel 32e. Further, in some embodiments, the lower panel 32d can be coupled to at least one of the front member 34, the rear panel 32e, and/or the side panels 32c in any of the previously mentioned coupling manners.

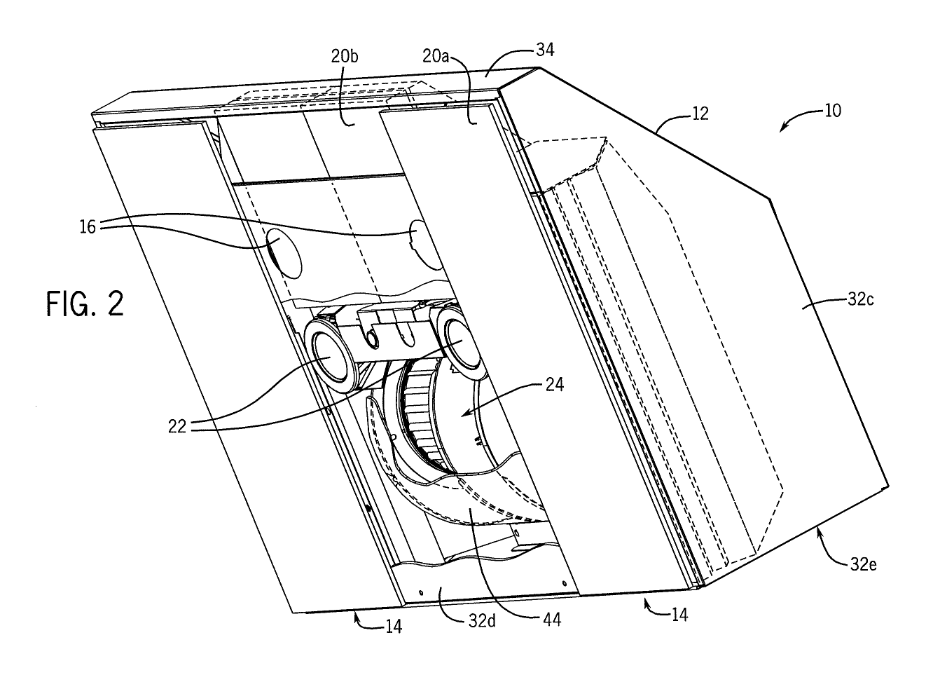

In some embodiments, the system 10 can be coupled to a portion of the building structure so that the lower panel 32d can be disposed substantially adjacent to a surface over which the housing 12 is installed. For example, in some embodiments, the system 10 can be coupled to a portion of a building structure so that the system 10 is substantially adjacent to a cooking surface (not shown). In some embodiments, the lower panel 32d can comprise one or more the first intakes 14 and the second intakes 16. As a result, in some embodiments, the lower panel 32d and at least one of the intakes 14, 16 can be substantially adjacent to the cooking surface. Moreover, in some embodiments, at least one of the intakes 14, 16 can be configured and arranged to receive and/or guide a fluid originating from the cooking surface (e.g., cooking effluent) and/or the local environment (e.g., ambient air) into the housing 12 and the system 10. Moreover, as shown in FIG. 2, in some embodiments, the system 10 can comprise two first intakes 14 disposed at least partially adjacent to lateral sides of the lower panel 32d and the second intakes 16 disposed in a generally central location (e.g., between the first intakes 14). Although future references refer to “fluid” as air, cooking effluent, or by other descriptors, these references are not intended to limit the scope of this disclosure to those particular embodiments, and should he understood as including all of the previously mentioned forms of a fluid.

In some embodiments, the system 10 can comprise the light assembly 22, as shown in FIG. 2. For example, in some embodiments, lower panel 32d can comprise at least one lighting aperture 36 through with the light assembly 22 can be positioned during assembly of the system 10. In some embodiments, light assembly 22 can comprise one or more illumination devices (not show). For example, in some embodiments, the illumination devices can comprise light-emitting diodes, compact fluorescent bulbs, incandescent bulbs, or any other type of illumination device. In some embodiments, the illumination devices can be configured and arranged to provide illumination to the surface (e.g., the cooking surface) below the housing 12.

By way of example only, in some embodiments, the fluid cleaning system 10 can comprise a hood assembly, as shown in FIGS. 1-5. Moreover, although some embodiments of this invention can comprise a similar amount of internal space relative to some conventional hood assemblies, some embodiments can make more efficient use of the any internal space defined by the housing 12. For example, in some embodiments, as shown in FIGS. 1 and 2, according to some embodiments of the invention, the housing 12 can receive, support, and/or retain some elements of the fluid cleaning system 10, as detailed in the following paragraphs. In some embodiments, the housing 12 can comprise a plurality of internal structures 38 (e.g., internal walls) disposed within the interior space of the housing 12 to provide support For other elements of the system 10. For example, in some embodiments, at least a portion of the elements disposed with the housing 12 can be support by and/or coupled to portions of the internal structures 38.

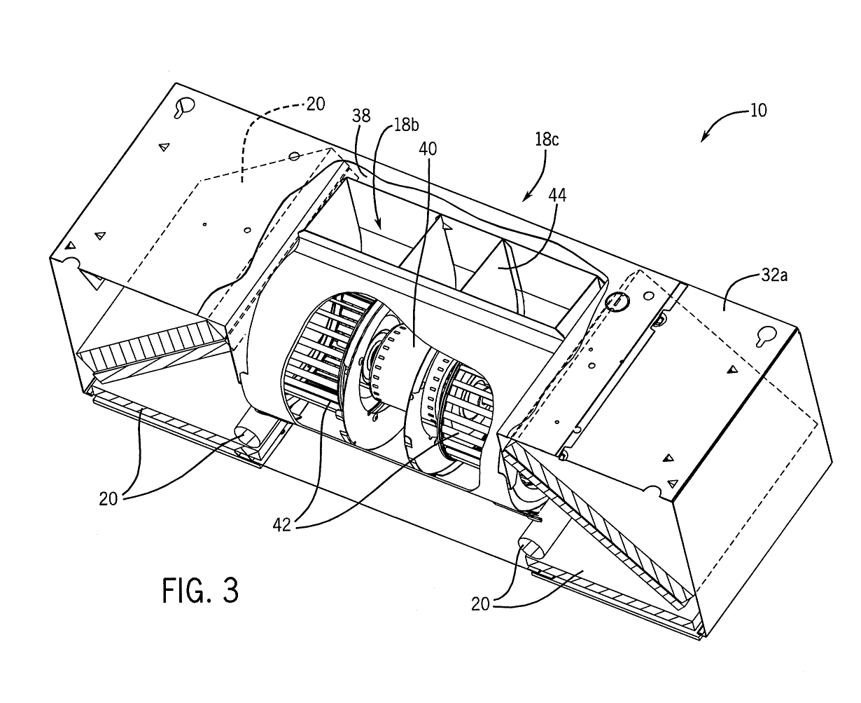

In some embodiments, the ventilating assembly 24 can he at least partially disposed within the housing 12, as shown in FIG. 3. In some embodiments, the ventilating assembly 24 can comprise a motor 40 operatively coupled to at least a portion of the internal structures 38 and at least one fan 42 drivably coupled to the motor 40. In some embodiments, at least one fan 42 can he coupled to each lateral side of the motor 40 to at least partially improve airflow relative to embodiments including only one fan 42. In some embodiments, the ventilating assembly 24 can comprise a substantially arcuate wall 44. In some embodiments, for example, the motor 28 and the fans 42 can be at least partially disposed within the arcuate wall 44 to define a scroll housing for generating a flow of fluid (e.g., air flow). For example, in some embodiments, the motor 40 and the fans 42 can be coupled to an interior portion of the arcuate wall 44 and the arcuate wall 44 can be coupled to the internal structures 38 of the housing 12.

In some embodiments, the ventilating assembly 24 can be disposed within the housing 12 so that it is in fluid communication with the intakes 14, 16 and at least one of the outlets 18a-18c. For example, in some embodiments, activation of the motor 40 can cause movement of at least one of the fans 42 to generate flow using the arcuate wall 44 so that the fluid flows out of the system 10 via at least one of the outlets 18a-18c. Moreover, in some embodiments, the generation of the fluid flow can also draw fluid into the system 10 via at least one of the intakes 14, 16.

In sonic embodiments, the filters 20 can be at least partially disposed within the housing 12. In some embodiments, the filters and/or media 20 can comprise large, activated Carbon bed filters. Carbon-coated fabric filters, ultra violet (UV) photo catalytic oxidation methods (e.g., UV light shining on Titanium Dioxide), UV lights, pleated high-efficiency particulate air (HEPA) filters, electrostatic filters, a fluid deodorizing system, which can include both chemical deodorizing and a dispersion method of deodorizing, and any other types of filters.

In some embodiments, a generally coarser-grade filter 20a can be disposed substantially adjacent to at least one of the first intake 14 and the second intakes 16. By way of example only, in some embodiments, the coarser-grade filter 20a can comprise a pre-filter 20a disposed immediately adjacent to at least one of the intakes 14, 16. In some embodiments, the pre-filter 20a can be configured and arranged to remove some air contaminants (e.g., cooking effluent such a grease, steam, etc.) prior to further fluid influx into the system 10. For example, in some embodiments, the pre-filter 20a can comprise a grease filter 20a so that when the system 10 is active during a cooking event, the grease filter can remove at least a portion of any grease and other contaminants before the fluid passes through other portions of the system 10. Additionally, in some embodiments, any or all of the plurality of filters/media 20 can be configured so that they can be bundled for easy maintenance or servicing of the system M. For example, in some embodiments, at least a portion of the filters 20 can be coupled together in a single structure (e.g., a filter pack) so that the filters 20 can be easily installed and replaced when necessary.

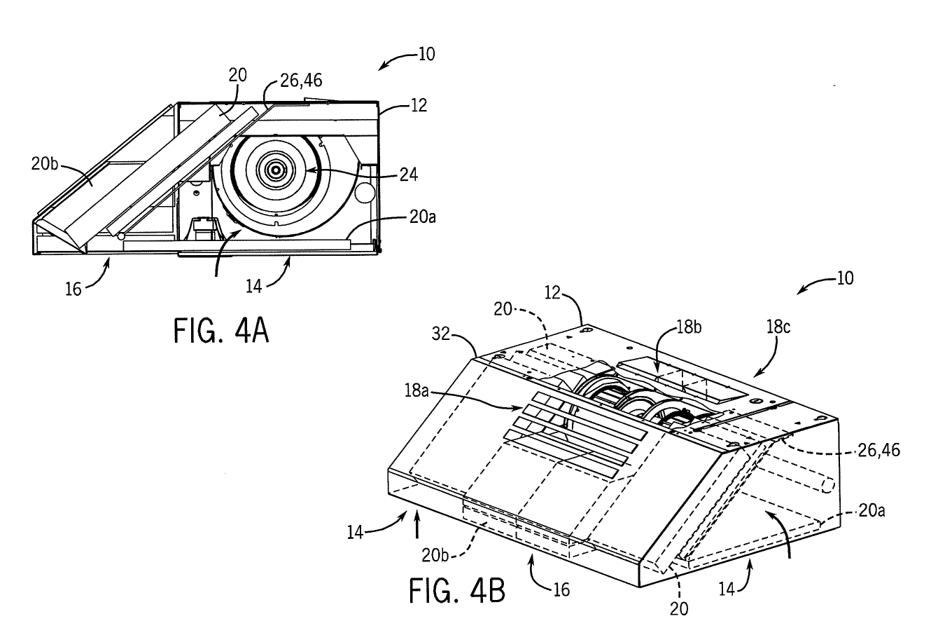

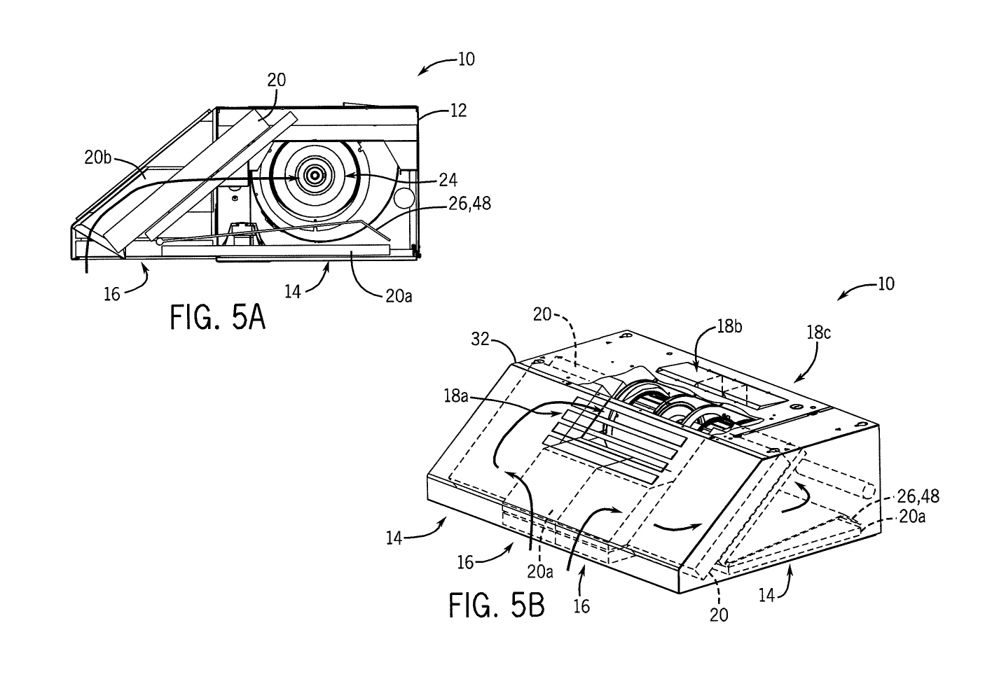

According to some embodiments of the invention, the housing 12 can comprise at least one shutter 26, as shown in FIGS. 4A-5B. In some embodiments, the housing 12 can comprise more than one shutter 26. In some embodiments, the shutters 26 can be movably coupled to the housing 12. By way of example, in some embodiments, at least one of the shutters 26 can be configured and arranged that the shutters 26 can be moved (e.g., rotated) between at least two different locations. In sonic embodiments, the shutters 26 can at least partially pivotably engage the housing 12 to enable movement between the at least two different locations. Moreover, in some embodiments, at least one of the shutters 26 can he dimensioned to comprise a substantially similar size (e.g., perimeter, surface area, etc.) as at least one of the intakes 14, 16. Furthermore, the shutters 26 can be disposed within the housing 12 so that, in at least one of the at least two different positions, at least one of the shutters 26 can be disposed substantially immediately adjacent to at least a portion of the filters 20 and/or the intakes 14, 16. For example, as described in further detail below, in some embodiments, when the fluid cleaning system 10 operates in a first mode of operation, the shutters 26 can be disposed in a first position 46 substantially adjacent to the second intakes 16 to at least partially restrict the fluid flow through the second intakes 16 and enable fluid flow through at least one of the first intakes 14. Moreover, in some embodiments, when the system 10 operates in a second mode of operation, the shutters 26 can be rotated or moved to a second position 48 so that at least one of the first intakes 14 is substantially obstructed by the shutters 26, which can enable fluid flow through the second intakes 16.

100321 In some embodiments of the invention, system 10 can he at least partially controlled by environmental changes sensed by the detection apparatus. For example, in some embodiments, the system 10 can use at least a portion of the signals received from the detection apparatus to determine which of the at least two modes of operation should be employed. In some embodiments, the detection apparatus can be coupled to at least one of the housing 12, the structure to which the housing 12 is coupled, and/or a location substantially adjacent to the surface over which the housing 12 is coupled (e.g., near the cooking surface). Moreover, in some embodiments, the system 10 can comprise a plurality of detection apparatuses so that a detection apparatus can be disposed in each of the previously mentioned locations and other locations (e.g., other rooms, spaces, or regions of the structure into which the system 10 is installed). Moreover, in some embodiments, the detection apparatus can be in communication with other portions of the system 10 (e.g., the shutters 26, the motor 40, etc.) so that after detection of certain indicia, the detection apparatus can relay the sensed environmental changes.

By way of example only and as previously mentioned, the system 10 can be coupled to a portion of a building so that the system 10 is substantially adjacent to a cooking surface (e.g., a stove top, cooking top, a range oven, etc.). Under some circumstances, it can be desirable to install the system 10 adjacent to the cooking surface because of the relatively large production of pollutants in this area of some buildings (e.g., arising from food preparation and disposal). For example, in some embodiments, the detection apparatus can detect a cooking event occurrence. In some embodiments, the detection apparatus can be configured and arranged to detect cooking events via heat sensing, gas sensing, infrared sensing, particulate sensing, or any other type of sensing that can detect a cooking event. Furthermore, in some embodiments, the system 10 can comprise a plurality of detection apparatuses that comprise different sensing capabilities. By way of example only, in some embodiments, a detection apparatus capable of sensing heat and/or gases can be coupled to the housing 12 (e.g., above the cooking surface) and other detection apparatus positioned substantially adjacent to the cooking surface capable of sensing other indicia of a cooking event (e.g., the presence of particulates). In some embodiments, as previously mentioned, the system 10 can be installed in other portions of buildings (e.g., garages, bedrooms, bathrooms, offices, etc.) to detect and treat any pollutants produced in those environments, and accordingly, the detection apparatus can be configured to sense other environmental indicators.

In sonic embodiments, when the detection apparatus detects changes in the local environment (e.g., a cooking event), it can direct the system 10 to operate in the first mode of operation. In some embodiments, in the first mode of operation, the detection apparatus can signal that the shutters 26 should move to the first position 46 so that the second intakes 16 are substantially obstructed by the shutters 26. In some embodiments, the detection apparatus can be in communication with the motor 40 or another structure capable moving the shutters 26. Accordingly, in some embodiments, upon detection of a cooking event, the motor 40 or other structure can move (e.g., rotate) the shutters 26 to the first position 46 substantially adjacent to the second intakes 16. In some embodiments, in the first mode of operation, the system 10 can activate the ventilating assembly 24 (e.g., provide current to the motor 40 to move the fans 42), which can lead to fluid (e.g., air from the local environment) circulating through the system 10.

For example, when system 10 activates the ventilating assembly 24 in the first mode of operation, a significant proportion of fluid entering the system 10 can flow into the housing 12 via at least one of the first intakes 14 because the shutters 26 have at least partially obstructed the second intakes 16 to prevent material amounts of fluid from circulating through the second intakes 16. Further, in some embodiments, the ventilating assembly 24 can be configured so that the fluid-flow rate (e.g., cubic feet per minute) of the first mode of operation can comprise a greater fluid-flow rate relative to a flow rate of the second mode of operation, as described in greater detail below.

In some embodiments, the housing 12 can comprise at least one first flow path (as reflected by the arrows in FIGS. 4A and 4B). In some embodiments, at least a portion of the internal structures 38, a portion of the shutters 26, portions of the housing 12, and/or portions of the ventilating assembly 24 can comprise portions of the first flow path. For example, the system 10 can comprise two first intakes 14 and two first flow paths extending from the first intakes 14 to the ventilating assembly 24 and toward at least one of the outlets 18a-18c. Accordingly, in some embodiments, in the first mode of operation, the system 10 can draw fluid from the surrounding environment through the first intakes 14 because the shutters 26 have substantially obstructed the second intakes 16. Moreover, after passing through the first intakes 14, at least a portion of the fluid can pass through the pre-filter 20a to reduce at least a portion of the pollutants carried by the fluid. For example, in some embodiments, the pre-filter 20a can comprise a grease filter 20a and the fluid can comprise cooking effluent, and, accordingly, as the cooking effluent passes through the grease filter 20a, at least a portion of the grease and other pollutants carried by the air can be received by the grease filter 20a to reduce the concentration of pollutants in the air. Moreover, in some embodiments, after flowing through the first intakes 14 and through the pre-filter 20a, at least a portion of the polluted fluid can enter the first flow path which guides the fluid through at least one of the outlets 18a-18e.

By way of example only, in some embodiments, the first flow path can direct at least a portion of the fluid through at least one of the second or third outlets 18b, 18c. In some embodiments, these outlets 18b, 18c can be fluidly connected to the previously mentioned duct system and/or the duct-free system. As a result, in some embodiments, the ventilating assembly 24 can direct at least a portion of the fluid through the duct system, which can guide the polluted fluid to a remote location (e.g., outside of the room and/or building). In some embodiments, the ventilating system 24 can direct at least a portion of the fluid through the duct-free system in addition to, or in place of, guiding some of the fluid to the duct system. As previously mentioned, in some embodiments, the duct-free system can comprise one or more filters (e.g., conventional carbon filters) that can further reduce the pollutant concentration of the fluid. As a result, in some embodiments, after flowing through the duct-free system, at least a portion of the fluid can be returned to the local environment with a pollution concentration that has been reduced by at least one of the pre-filter 20a or the one or more filters 20 in the duct-free system. In some embodiments, the first flow path can comprise guiding at least a portion of the fluid through the first outlet 18a in addition to, or in lieu of, directing a portion of the fluid through at least one of the other outlets 18b, 18c. Accordingly, in some embodiments, by circulating at least a portion of a polluted fluid through the first flow path when the system 10 is operating in the first mode of operation, the pollution concentration (e.g., concentration of cooking effluent) can he at least partially reduced.

In some embodiments of the invention, when the detection apparatus is active, but does not sense pre-selected changes in the local environment (e.g., a lack of a cooking event) or does not sense a significant enough change in the local environment, the detection apparatus can be configured and arranged to direct the fluid cleaning system 10 to at least partially function in the second mode of operation. In some embodiments, when the detection apparatus is active, but fails to sense pre-selected changes in the local environment, the detection apparatus can cause the shutters 26 to move (e.g., via the motor 40 or other structures) to the second position 48. In some embodiments, the second position 48 can comprise a location substantially immediately adjacent to at least one of the first intakes 14. For example, in some embodiments comprising two first intakes 14, in the second mode of operation, the second position 48 can comprise locations substantially adjacent to the first intakes 14, as shown in FIGS. 5A and 58. As a result of the shutters 26 being disposed substantially adjacent to the first intakes 14, at least a portion of the fluid flow through these intakes 14 can be substantially obstructed. For example, in some embodiments, when the shutters 26 move to the second position 48, a greater portion of fluid can enter the system via the second intakes 16 than the first intakes 14. Moreover, in some embodiments, the shutters 26 can substantially seal the first intakes 14 so that no material amounts of fluid enter the system 10 via the first intakes 14.

In some embodiments, when functioning in the second mode of operation, the system 10 can comprise at least some different operational parameters relative to the first mode of operation. In some embodiments, the ventilating assembly 24 can be configured and arranged to generate multiple fluid-flow rates, which can enable flexible uses of the system 10. For example, in some embodiments, the ventilating assembly 24 can generate a lesser flow rate in the second mode of operation compared to the first mode of operation. Moreover, in some embodiments, the second mode of operation can comprise at least one second flow path, as reflected by the arrows in FIGS. 5A and 58, and described in further detail below. As a result, in some embodiments, the system 10 can function as an ambient air cleaner when in the second mode of operation. For example, in some embodiments, in the second mode of operation, the system 10 can substantially continuously circulate ambient air through the second flow path to improve local air quality, even in the absence of cooking events.

In some embodiments, similar to the first flow path, the second flow path can direct fluid through the system 10 to reduce pollution concentrations. For example, in some embodiments, fluid can enter the system 10 via the second intakes 16 and circulate through a pre-filter 20b disposed substantially immediately adjacent to, and in fluid communication with the second intakes 16. Moreover, in some embodiments, after passing through the pre-filter 20b, at least a portion of the fluid can pass through the plurality of filters/media 20. As a result, in some embodiments, the pre-filter 20b and the filters/media 20 can substantially reduce the concentration of odors, VOCs, fine particulates, or any other product or pollutant that a user wishes to remove from the local environment. In some embodiments, after at least a portion of the fluid passes through the filters 20, 20b, the ventilating assembly 24 can direct the fluid through at least one of the outlet 18a-18c. For example, in some embodiments, at least a portion of the fluid can circulate through the ventilating assembly 24 and be circulated through the first outlet 18a and returned the local environment with a reduced concentration of pollutants. Furthermore, as previously mentioned, in some embodiments, when the system 10 operates in the second mode of operation, it can operate at a substantially reduced, but substantially continuous, flow rate so that ambient air quality can be improved. Moreover, by operating at a reduced flow rate, the ventilating assembly 24 can aid in enhancing air quality while consuming a reduced quantity of power and producing reduced levels of noise when operating in the second mode of operation.

In some embodiments of the invention, the system 10 can include the user interface. In some embodiments, the user interface can be configured and arranged to serve as a controller for the fluid cleaning system 10 as well as a portal to provide feedback to the user. For example, in some embodiments, the user can employ the user interface to select different levels of operation depending on desired local air quality (e.g., the user can select different flow rates). Additionally, in some embodiments, the user interface can be used to set the system 10 to automatically adjust operation based on a desired goal of air quality. Further, the user interface can provide visual feedback to the user regarding the current state of the local air quality using an apparatus such as a light-emitting diode indicator or any other suitable structures. In some embodiments, the user interface can be coupled to the housing 12 in a location that the user can access. In some embodiments, the user interface can be disposed at locations remote to the housing 12 so that the user need not be immediately adjacent to the housing 12 to adjust operations of the system 10. Furthermore, in some embodiments, the system 10 can comprise multiple user interfaces so that the user can access a user interface both at the housing 12 and at one or more remote locations.

The following description serves as an example of operations of the fluid cleaning system 10 according to some embodiments of the invention and is not intended to limit the scope of the invention.

In some embodiments, the system 10 can be activated at the user interface. For example, in some embodiments, user can activate the system 10 so that it will substantially continuously operate in the second mode of operation unless the detection apparatus senses a predetermined change in the local environment, such as the occurrence of a cooking event. According, when in the second mode of operation, the shutters 26 can be disposed in the second position 48 so that the first intakes 14 are substantially sealed (e.g., no material amounts of air enter the system 10 via the intakes 14). In the second mode of operation, the ventilating assembly 24 can generate a substantially continuous airflow at a generally reduced airflow rate (e.g., relative to the first mode of operation). As a result, in some embodiments, local air can be drawn into the housing 12 via the second intakes 16 and pass through the pre-filter 20b before entering the second flow path. The second flow path can guide at least a portion of the air through the plurality of filters/media 20 to reduce pollution concentration and generally improve the air quality. After passing through the filters/media 20, at least a portion of the air is returned to the local environment via the first outlet 18a, which can lead to improved air quality in the local environment.

In some embodiments, the system 10 can substantially continue to operate in the second mode of operation until the user deactivates the system 10 (e.g., via the user interface), the ambient air quality achieves the user's desired level of quality, and/or the detection apparatus detects a cooking event. In some embodiments, if the detection apparatus senses a cooking event, the system 10 can change from the second mode of operation to the first mode of operation. In some embodiments, the shutters 26 can be moved (e.g., rotated, slid, or otherwise moved) from the second position 48 to the first position 46, in which case air flow through the second intakes 16 can be substantially stopped. After the shutters 26 move to the first position 46 the ventilating assembly 24 can draw cooking effluent through the first intakes 14 and the pre-filters 20a, which can remove a portion of the pollution from the air. Then, the ventilating assembly 24 can circulate the air out of the system 10 via at least one of the outlets 18b, 18c. For example, in some embodiments, the air can enter a duct system, which can guide at least a portion of the air to an external environment (e.g., outside of the building). In some embodiments, in addition to, or in lieu of the duct system, at least a portion of the air can enter a duct-free system where the air can circulate through filters to further reduce the concentration of pollutants and then he returned to the local environment.

Additionally, in some embodiments, in the first mode of operation, the ventilating assembly 24 can increase airflow rate to enable a greater volume of air to be circulated through the system 10. For example, by increasing flow rate, the more heavily-polluted air (e.g., cooking effluent) can be more readily stripped of its pollutants or circulated away from the local environment to improve air quality. In some embodiments, once the detection apparatus can no longer senses the cooking event or the air quality is of a sufficient level, the system 10 can return to the second mode of operation or he deactivated. As a result, in some embodiments, the system 10 can function to substantially continuously improve air quality, which can ensure a higher quality living environment. Moreover, by combining the function of a hood assembly (i.e., removing cooking effluent or other heavily-soiled fluids) and the function of an air cleaner (i.e., continuously improving the air quality at lower flow rates) into a single apparatus, the user can enjoy improved air quality without having to acquire, configure, and use two different systems.

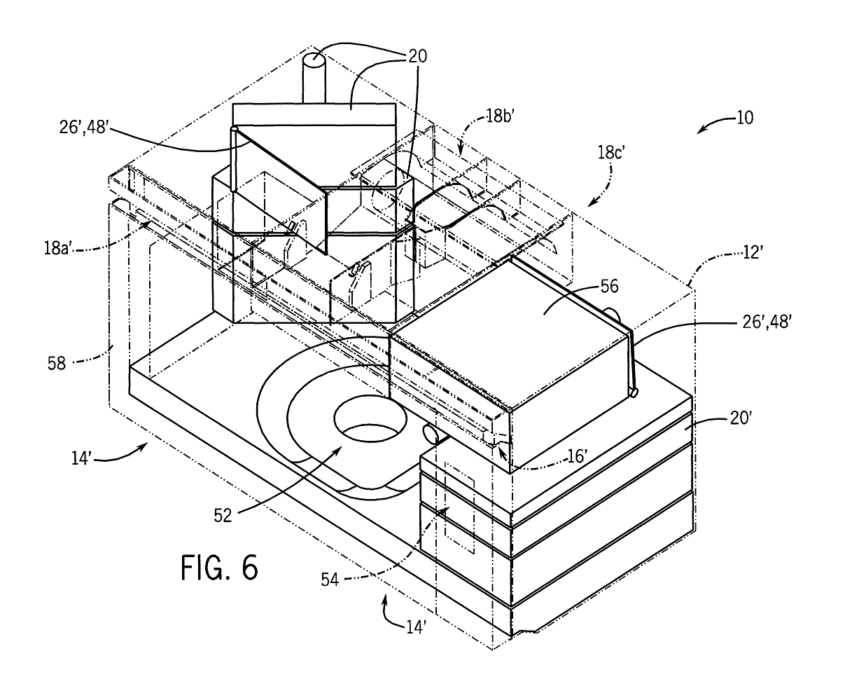

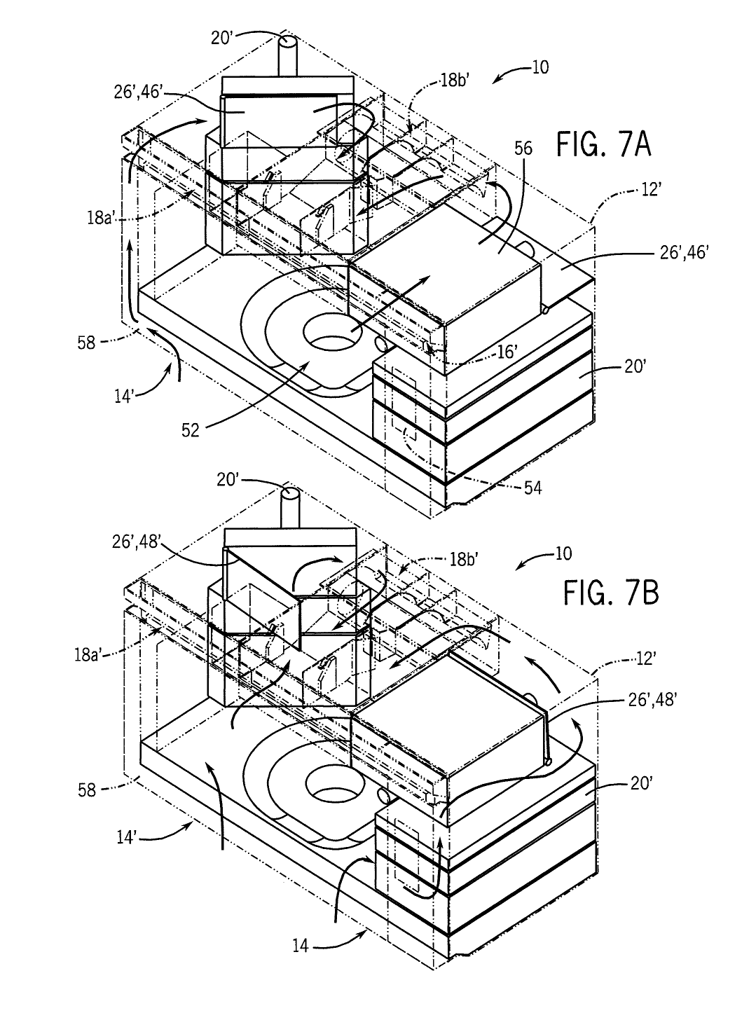

FIGS. 6-7B illustrate the fluid cleaning system 10 according to other embodiments of the invention. In some embodiments, the system 10 can be at least partially disposed within a different housing 12. For example, in some embodiments, the system 10 can be at least partially disposed within an appliance, such as an over-the-range microwave oven. Although the following description uses an over-the-range microwave oven as an exemplary housing 12 for the system 10, it is not intended to limit these embodiments only to over-the-range microwave ovens. In some embodiments, the system 10 generally can include at least one first intake 14′, at least one second intake 16′, at least two modes of operation, a first outlet 18a′, a second outlet 18b′, a third outlet 18c′, a plurality of filters/media 20′, a ventilating assembly (not shown), a detection apparatus (not shown) and at least one shutter 26′.

In some embodiments of the invention, the system 10 can include a housing 12′, a cooking area 52, a user interface 54, electronics 56, and a door 58 operatively coupled to the housing 12′. In some embodiments, the cooking area 52 can be located substantially within the housing 12′ while the user interface 54 can be located on an outside surface of the housing 12′, which can enable user access to the user interface 54. In some embodiments, the ventilating assembly can be disposed substantially within the housing 12′ and configured and arranged to generate airflow within the system 10. For example, the ventilating assembly can draw a volume of air or other fluids through the intakes 14′, 16′.

In some embodiments, the intakes 14′, 16′ can be at least partially disposed through a portion of the housing 12′ so that they are in fluid communication with the local environment. In some embodiments, the first intake 14′ can be located generally at the bottom of the housing 12′ (e.g., substantially adjacent to a lower portion of the door 58), and the second intake 16′ can be located at the front of the housing 12′ (e.g., substantially adjacent to the electronics 56 and/or the user interface 54). In some embodiments, the first intake 14′ can be configured and arranged to enable ventilation of an area below the oven 50 when odor, particulate, or other pollution is being generated, such as during a cooking event. In some embodiments, the second intake 16′ can be configured and arranged to increase flow around the electronics 56, which can lead to cooling during operation of the microwave oven 50. Also, in some embodiments, a pre-filter (not shown) can be disposed substantially immediately adjacent to the intakes 14′, 16′. The pre-filter can serve to initially reduce the amount of undesirable pollutants.

In some embodiments, the outlets 18a′-18c′ can be disposed through a substantially upper portion of the housing 12′. In some embodiments, the first outlet 18a′ can be disposed through a portion of the housing 12′ at a front region of housing 12′ (e.g., substantially above the door 58) and substantially adjacent to the second intake 16′. In some embodiments, the second outlet 18b ′ can he disposed through a top portion of the housing 12′ (e.g., substantially perpendicular to a horizontal axis of the housing 12′) and the third outlet 18c′ can be disposed through a rear portion of the housing 12′ (e.g., substantially perpendicular to the second outlet 18b′). In some embodiments, at least one of the second and third outlets 18b′, 18c′ can fluidly connect the system 10 to a duct system (not shown) that can lead to venting of polluted fluids outside of the local environment, including venting outside of a structure into which the system 10 is installed (not shown). In some embodiments, one or both of the outlets 18b′, 18c′ can be in fluid communication with a duct-free system (not shown). In some embodiments, the duct-free system can include filters (not shown) (e.g., carbon filters) that can be configured and arranged to at least partially reduce the pollution concentration of the fluid and return at least a portion of the fluid to the local environment. Moreover, in some embodiments, the outlets 18b′, 18c′ can be connected to neither the duct system nor the duct-free system and vent the fluid to the local environment. In some embodiments, the outlets 18b′, 18c′ can be coupled to one of or both of the duct system and the duct-free system.

In some embodiments, the plurality of filters/media 20′ also can be positioned within the housing 12′. As shown in FIGS. 7A and 7B, in some embodiments, the filters/media 20′ can he disposed in areas of the housing 12′ substantially laterally adjacent to the cooking chamber 52. The filters/media 20′ can include large, activated Carbon bed filters, Carbon-coated fabric filters, UV photo catalytic oxidation methods (i.e., UV light shining on Titanium Dioxide), pleated HEPA filters, electrostatic filters, a fluid deodorizing system, which can include both chemical fluid deodorizing and a dispersion method of fluid deodorizing, and any other suitable fluid cleaning filter. Further, in some embodiments, any or all of the plurality of filters/media 20′ can be configured so that they can he bundled for easy maintenance or servicing of the system 10.

According to some embodiments of the invention, the system 10 can comprise at least one shutter 26′. In some embodiments, the housing 12′ can comprise more than one shutter 26′. In some embodiments, the shutters 26′ can be movably coupled to the housing 12′. By way of example, in sonic embodiments, at least one of the shutters 26′ can be movably coupled so that the shutters 26′ can he moved (e.g., rotated) between at least two different locations. In some embodiments, the shutters 26′ can at least partially pivotably engage the housing 12′ to enable movement between the at least two different locations. Furthermore, the shutters 26′ can be disposed within the housing 12′ so that, in at least one of the at least two different positions, at least one of the shutters 26′ can he disposed substantially immediately adjacent to at least a portion of the filters 20′. For example, as described in further detail below, in some embodiments, when the fluid cleaning system 10 operates in a first mode of operation, the shutters 26′ can be disposed in a first position 46′ and enable fluid flow through a first :flow path. Moreover, in some embodiments, when the system 10 operates in a second mode of operation, the shutters 26′ can be rotated or moved to a second position 48′ and enable fluid flow through a second flow path.

In some embodiments of the invention, system 10 can be at least partially controlled by environmental changes sensed by the detection apparatus. For example, in some embodiments, the system 10 can use at least a portion of the signals received from the detection apparatus to determine which of the at least two modes of operation should be employed. In some embodiments, the detection apparatus can be coupled to at least one of the housing 12′, the structure to which the housing 12′ is coupled, and/or a location substantially adjacent to the surface over which the housing 12′ is coupled (e.g., near the cooking surface). Moreover, in some embodiments, the system 10 can comprise a plurality of detection apparatuses so that a detection apparatus can be disposed in each of the previously mentioned locations and other locations (e.g., other rooms, spaces, or regions of the structure into which the system 10 is installed). Moreover, in some embodiments, the detection apparatus can be in communication with other portions of the system 10 (e.g., the shutters 26′) so that after detection of certain indicia, the detection apparatus can relay the sensed environmental changes.

By way of example only and as previously mentioned, the system 10 can be coupled to a portion of a building so that the system 10 is substantially adjacent to a cooking surface (e.g., a stove top, cooking top, a range oven, etc.). Under some circumstances, it can be desirable to install the system 10 adjacent to the cooking surface because of the relatively large production of pollutants in this area of some buildings (e.g., arising from food preparation and disposal). For example, in some embodiments, the detection apparatus can detect a cooking event occurrence. In some embodiments, the detection apparatus can be configured and arranged to detect cooking events via heat sensing, gas sensing, infrared sensing, particulate sensing, or any other type of sensing that can, detect a cooking event. Furthermore, in some embodiments, the system 10 can comprise a plurality of detection apparatuses that comprise different sensing capabilities. By way of example only, in some embodiments, a detection apparatus capable of sensing heat and/or gases can be coupled to the housing 12′ (e.g., above the cooking surface) and other detection apparatus positioned substantially adjacent to the cooking surface capable of sensing other indicia of a cooking event (e.g., the presence of particulates). In some embodiments, as previously mentioned, the system 10 can he installed in other portions of buildings (e.g., garages, bedrooms, bathrooms, offices, etc.) to detect and treat any pollutants produced in those environments, and, accordingly, the detection apparatus can he configured to sense other environmental indicators.

In some embodiments, when the detection apparatus detects changes in the local environment (e.g., a cooking event), it can direct the system 10 to operate in the first mode of operation. In some embodiments, in the first mode of operation, the detection apparatus can signal that the shutters 26′ should move to the first position 46′ so that the second flow path is substantially obstructed by the shutters 26′. In some embodiments, the detection apparatus can be in communication with a motor (not shown) or another structure capable of moving the shutters 26′. Accordingly, in some embodiments, upon detection of a cooking event, the motor or other structure can move (e.g., rotate) the shutters 26′ to the first position 46′. In some embodiments, in the first mode of operation, the system 10 can activate the ventilating assembly, which can lead to fluid (e.g., air from the local environment) circulating through the system 10.

For example, when the system 10 activates the ventilating assembly in the first mode of Operation, at least a portion of the fluid entering the system 10 can flow into the system 10 via the intakes 14′, 16′, as shown in FIGS. 7A and 7B. Further, in some embodiments, the ventilating assembly can be configured so that the flow rate of the first mode of operation can comprise a greater flow rate relative to a flow rate of the second mode of operation, as described in greater detail below.

In some embodiments, after entering the system 10, in the first mode of operation, the fluid can circulate through the housing 12 in the first flow path, as denoted by the arrows in FIG. 7A. In some embodiments, the first flow path can comprise flowing through the first and the second intakes 14′, 16′ and passing through one or more pre-filters to remove at least a portion of the pollution carried by the fluid. Moreover, in some embodiments, when the shutters 26′ are in the first position 46′ and obstruct the second flow path, at least a portion of the filters 20 can be obstructed, except for the pre-filter. As a result, in some embodiments, the first flow path can further comprise directing the fluid to at least one of the outlets 18a′-18c′. For example, as shown in FIG. 7A, at least a portion of the fluid can flow through the intakes 14′, 16′, pass through the pre-filter, and then the ventilating assembly can exhaust the fluid via at least one of the outlets 18a′-18c′. Additionally, in some embodiments, in addition to enabling :fluid flow into the system 10, the second intake 16′ can aid in cooling of the electronics 56 (e.g., because fluid can flow adjacent to the electronics 56 when entering the system 10 via the second intake 16′).

Moreover, after passing through the intakes 14′, 16′, at least a portion of the fluid can pass through the pre-filter to reduce at least a portion of the pollutants carried by the fluid. For example, in some embodiments, the pre-filter can comprise a grease filter and the fluid can comprise cooking effluent, and, accordingly, as the cooking effluent passes through the grease filter, at least a portion of the grease and other pollutants carried by the fluid can he received by the grease filter to reduce the concentration of pollutants in the air.

By way of example only, in some embodiments, the first flow path can direct at least a portion of the fluid through at least one of the second or third outlets 18h′, 18c′. In some embodiments, these outlets 18b′, 18c′ can be fluidly connected to the previously mentioned duct system and/or the duct-free system. As a result, in some embodiments, the ventilating assembly can direct at least a portion of the fluid through the duct system, which can guide the polluted fluid to a remote location (e.g., outside of the room and/or building). In some embodiments, the ventilating system can direct at least a portion of the fluid through the duct-free system in addition to, or in place of guiding some of the fluid to the duct system. As previously mentioned, in some embodiments, the duct-free system can comprise one or more filters (e.g., conventional carbon filters) that can further reduce the pollutant concentration of the fluid. As a result, in some embodiments, after flowing through the duct-free system, at least a portion of the fluid can be returned to the local environment with pollution concentration that has been reduced by at least one of the pre-filter or the one or more filters in the duct-free system. In some embodiments, the first flow path can comprise guiding at least a portion of the fluid through the first outlet 18a′ in addition to, or in lieu of, directing a portion of the fluid through at least one of the other outlets 18b′, 18c′. Accordingly, in some embodiments, by circulating at least a portion of a polluted fluid through the first flow path when the system 10 is operating in the first mode of operation, the pollution concentration (e.g., concentration of cooking effluent) can be at least partially reduced.

In some embodiments of the invention, when the detection apparatus is active, but does not sense pre-selected changes in the local environment (e.g., the absence of a cooking event) or does not sense a significant enough change in the local environment, the detection apparatus can be configured and arranged to direct the fluid cleaning system 10 to at least partially function in the second mode of operation. In some embodiments, when the detection apparatus is active, but fails to sense pre-selected changes in the local environment, the detection apparatus can cause the shutters 26′ to move (e.g., via the motor or other structures) to the second positions 48′. In some embodiments, the second positions 48′ can comprise locations that can at least partially obstruct at least a portion of the first flow path and the second intake 16′. As a result of the shutters 26′ substantially obstructing the first flow path and the second intake 16′, at least a portion of the fluid flow through these areas can be at least partially restricted. For example, in some embodiments, when the shutters 26′ move to the second positions 48′, a greater portion of fluid can enter the system via the first intake 14′ than the second intake 16′. Moreover, in some embodiments, the shutters 26′ can substantially seal the second intake 16′ so that no material amounts of fluid enter the system 10 via the second intakes 16′.

In some embodiments, when functioning in the second mode of operation, the system 10 can comprise at least some different operational parameters relative to the first mode of operation. In some embodiments, the ventilating assembly can be configured and arranged to generate multiple fluid-flow rates, which can enable flexible uses of the system 10. For example, in sonic embodiments, the ventilating assembly can generate a lesser fluid-flow rate in the second mode of operation compared to the first mode of operation. Moreover, in some embodiments, the second mode of operation can comprise the second flow path, as reflected by the arrows in FIGS. 7A and 7B. As a result, in some embodiments, the system 10 can function as an ambient air cleaner when in the second mode of operation. For example, in some embodiments, in the second mode of operation, the system 10 can substantially continuously circulate ambient air through the second flow path to improve local air quality, even when no cooking events occur.

In some embodiments, similar to the first flow path, the second flow path can direct fluid through the system 10 to reduce pollution concentrations. For example, in some embodiments, fluid can enter the system 10 via the first intakes 14′ and circulate through the pre-filter. Moreover, in some embodiments, after passing through the pre-filter, at least a portion of the fluid can pass through the plurality of filters/media 20, as shown in FIGS. 6-7B. As a result, in some embodiments, the pre-filter and the filters/media 20 can substantially reduce the concentration of odors, VOCs, fine particulates, or any other product or pollutant that a user wishes to remove from the local environment. In some embodiments, after at least a portion of the fluid passes through the filters 20, the ventilating assembly can direct the fluid through at least one of the outlet 18a′-18c′. For example, in some embodiments, at least a portion of the fluid can circulate through the ventilating assembly and be circulated through the first outlet 18a′ and returned the local environment with a reduced concentration of pollutants. Furthermore, as previously mentioned, in some embodiments, when the system 10 operates in the second mode of operation, it can operate at a substantially reduced, but substantially continuous, flow rate so that ambient air quality can be improved. Moreover, by operating at a reduced flow rate, the ventilating assembly can aid in enhancing air quality while consuming a reduced quantity of power and producing reduced levels of noise when operating in the second mode of operation. As a result, in some embodiments, the system 10 can function to substantially continuously improve air quality, which can ensure a higher quality living environment. Moreover, by combining the function of a microwave oven assembly (i.e., removing cooking effluent or other heavily-soiled fluids and being capable of preparing food) and the function of an air cleaner (i.e., continuously improving the air quality at lower flow rates) into a single apparatus, the user can enjoy improved air quality without having to acquire, configure, and use two different systems.

In some embodiments of the invention, the system 10 can include the user interface 54. In some embodiments, the user interface 54 can be configured and arranged to serve as a controller for the fluid cleaning system 10 as well as a portal to provide feedback to the user. For example, in some embodiments, the user can employ the user interface 54 to select different levels of operation depending on desired local air quality (e.g., the user can select different flow rates). Additionally, in some embodiments, the user interface 54 can be used to set the system 10 to automatically adjust operation based on a desired goal of air quality. Further, the user interface 54 can provide visual feedback to the user regarding the current state of the local air quality using an apparatus such as a light-emitting diode indicator or any other suitable structures. In some embodiments, the user interface 54 can be coupled to the housing 12′ in a location that the user can access. For example, in some embodiments, the user interface 54 can comprise a substantially similar configuration to a conventional microwave oven user's panel (e.g., including buttons for controlling cook time, a kitchen timer, etc.). In some embodiments, the user interface 54 can be disposed at locations remote to the housing 12′ so that the user need not be immediately adjacent to the housing 12′ to adjust operations of the system 10. Furthermore, in some embodiments, the system 10 can comprise multiple user interfaces 54 so that the user can access a user interface 54 both at the housing 12 and at one or more remote locations.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A fluid cleaning system comprising:
a housing capable of being coupled to a building structure;
at least one first intake and at least one second intake being disposed through a portion of the housing;
at least one outlet being disposed through a portion of the housing;
a ventilating assembly supported within the housing, the ventilating assembly capable of generating a fluid flow;
at least one detection apparatus being in communication with the ventilating assembly;
at least one shutter operatively coupled to the housing, the at least one shutter configured and arranged to move between at least a first position and a second position; and
at least one filter supported within the housing.

2. The system of claim 1 and further comprising a plurality of filters supported within the housing.

3. The system of claim 2, wherein the plurality of filters comprises at least one pre-filter supported within the housing and disposed substantially adjacent to the at least one first intake.

4. The system of claim 2, wherein the plurality of filters comprises at least one of Carbon bed filters, Carbon-coated fabric filters, an ultra-violet photo catalytic oxidation apparatus, an ultra-violet light bulb, pleated high-efficiency particulate air filter, an electrostatic filter and a fluid deodorizing system.

5. The system of claim 2, wherein at least two of the plurality of filters comprise pre-filters supported within the housing and disposed substantially adjacent to the at least one first intake and the at least one second intake.

6. The system of claim 1, wherein the first position comprises a location substantially adjacent to the at least one second intake.

7. The system of claim 1, wherein the second position comprises a location substantially adjacent to the at least one first intake.

8. The system of claim 1, wherein the detection apparatus is configured and arranged to detect a cooking event.

9. The system of claim 1 and further comprising a user interface.

10. The system of claim 1 and further comprising a plurality of outlets disposed through a portion of the housing.

11. The system of claim 10, wherein at least one of the plurality of outlets is configured and arranged to be coupled to at least one of a duct system of the building structure and a duct-free system comprising at least one filter.

12. A fluid cleaning system comprising:
a housing capable of being coupled to a building structure, the housing including at least one first flow path and at least one second flow path;
at least one first intake and at least one second intake being disposed through a portion of the housing;
at least one outlet being disposed through a portion of the housing;
at least one shutter operatively coupled to the housing, the at least one shutter configured and arranged to move between a first position and a second position, and wherein the first position obstructs at least a portion of the at least one second flow path and the second position obstructs at least a portion of the first flow path;
at least one detection apparatus coupled to the housing;
a plurality of filters being supported within the housing, wherein at least a portion of the plurality of filters is in fluid communication with the at least one first flow path and at least another portion of the plurality of filters is in fluid communication with the at least one second flow path; and
a ventilating assembly supported in the housing, the ventilating assembly being configured and arranged to generate a fluid flow through the housing, and wherein the ventilating assembly is in fluid communication with the at least one first flow path and the at least one second flow path.

13. The system of claim 12, wherein the plurality of filters comprises at least one of Carbon bed filters, Carbon-coated fabric filters, an ultra-violet photo catalytic oxidation apparatus, an ultra-violet light bulb, pleated high-efficiency particulate air filter, an electrostatic filter, and a fluid deodorizing system.

14. The system of claim 12, wherein the ventilating system is configured and arranged to operate in a first mode of operation and a second mode of operation.

15. The system of claim 14, wherein the first mode of operation comprises the ventilating system being capable of generating a greater fluid flow rate than when the ventilating system operates in the second mode of operation.

16. The system of claim 12, wherein the housing comprises a microwave oven.

17. The system of claim 12, wherein the detection apparatus is configured and arranged to detect a cooking event.

18. The system of claim 17, wherein the detection apparatus senses the cooking event by at least one of heat sensing, gas sensing, infrared sensing, and particulate sensing.

19. A method of assembling a fluid cleaning system, the method comprising:
providing a housing capable of being coupled to a building structure;
disposing at least one first intake and at least one second intake through a portion of the housing;
disposing at least one outlet through a portion of the housing;
coupling a ventilating assembly to the housing, the ventilating assembly being capable of generating a fluid flow;
coupling at least one detection apparatus to the housing;
operatively coupling at least one shutter to the housing, the at least one shutter configured and arranged to move between at least a first position and a second position; and
positioning at least one filter within the housing.

20. The method of claim 19, wherein the first position comprises a location substantially adjacent to the at least one second intake and the second position comprises a location substantially adjacent to the at least one first intake.
